(19) United States
(12) Patent Application Publication
(10) Pub. No.: US 2005/0170123 A1
(43) Pub. Date: Aug. 4, 2005

(54) Pressure sensitive label

(76) Inventor: Colleen Zielske, Louisville, KY (US)

Correspondence Address: EMCH, SCHAFFER, SCHAUB & PORCELLO CO, P O BOX 916, ONE SEAGATE SUITE 1980, TOLEDO, OH, 43697, US

(21) Appl. No.: 10/775,955

(22) Filed: Feb. 9, 2004

Related U.S. Application Data
(60) Provisional application No. 60/454,221, filed on Mar. 13, 2003.
(60) Provisional application No. 60/515,466, filed on Oct. 29, 2003.

(51) Int. Cl. B32B 9/00

(52) U.S. Cl. 428/40.1

(57) ABSTRACT

A pressure sensitive label has a water dispersible adhesive as the bottom functional layer adjoining a container wall or other surface. A variety of as-manufactured structures are disclosed including ones in which one or more layers of the as-manufactured structure may be removed prior to adherence to a surface and ones which may be rolled up into a roll.

### CROSS REFERENCE TO RELATED APPLICATION

This application is based upon and claims the benefit of Provisional Patent Applications Ser. Nos. 60/454,221 filed Mar. 13, 2003 and 60/515,466 filed Oct. 29, 2003.

### BACKGROUND OF THE INVENTION

The present invention is directed to a multilayer pressure sensitive adhesive label having a water dispersible adhesive as the bottom functional layer adjoining a container wall or other surface. Although the label of the present invention may be used with a container intended for packaging goods for extended periods of time, it is particularly well suited as a label applied to a pan or other type of container from which foods in a restaurant may be served. One embodiment will be described specifically as it relates to use in a food rotation application where, after a predetermined length of time in which the food has been in a serving container, it will be deemed to have passed beyond the safe useable length of time in such serving container and will be discarded. At that time, it is desirable that the label be readily removable from the container in order that such container can be washed and then re-stocked with fresh food, either hot or cold, with a new label affixed to the container which contains new expiration indicia. It is desirable that the label as adhered to the container be readily removable without significant traces portions of the removed label in order that the container can be quickly relabeled and restocked with food. It is also desirable that a layer of the label, following removal from the container remain intact and not be dissolved or dispersed by water.

Other embodiments include a variety of structures which can be rolled up to form a roll of labels.

Under one embodiment, the label of the present invention has five layers as manufactured including a release liner which is removed prior to affixing to the container. For purposes of clarity, the label as manufactured will be referred to as the “as-manufactured” label and the label as affixed to a container will be referred to as the “as-affixed” label. Thus, the as-affixed label of such embodiment has four layers, namely, a water dispersible adhesive layer which is adhered to the container immediately following removal of the release liner, a carrier sheet layer, a layer of conventional pressure sensitive adhesive and a top or outwardly facing indicia layer which may have printed indicia on its outwardly facing surface. The release liner of the as-manufactured label is adjacent the layer of water dispersible adhesive.

A significant feature of the present invention resides in its functionality in which an outwardly facing indicia layer can be removed from the container and retained for record keeping and one or more layers remain with the container and can be washed away. An additional feature of the present invention is that the face stock retains its integrity even during storage in refrigerators or other areas with high condensation or high humidity.

### IN THE DRAWINGS

FIG. 1 is a sectional view showing the structure of one embodiment of an as-manufactured label.

FIG. 2 is a schematic sectional view showing removal of the release liner preparatory to affixing the label to a container.

FIG. 3 is a sectional view of a food container wall with the as-affixed label applied thereto.

FIG. 4 is a view similar to FIG. 3 but showing the step of removing the outer indicia layer and the adhesive layer adhered thereto from the carrier sheet and leaving the water dispersible adhesive layer adhering such carrier sheet to the container.

FIG. 5 is a schematic view showing directing water at the side wall of the container to readily remove the carrier sheet and water dispersible adhesive layer from the container.

FIG. 6 is a sectional view of another embodiment of an as-manufactured label.

FIG. 6A is a schematic sectional view of the embodiment of FIG. 6 showing removal of a backing layer and its release coating preparatory to affixing the label to a substrate.

FIG. 7 is a sectional view of an embodiment showing the label structure being formed into a roll of labels.

FIG. 7A shows a label unwound from the roll of FIG. 7 being affixed to a substrate.

FIG. 8 is a sectional view of an additional embodiment of label structure being formed into a roll of labels.

FIG. 8A shows a label unwound from the label structure of FIG. 8 being applied to a substrate.

FIG. 8B shows a label having the structure of FIG. 8 following affixing to the substrate shown in FIG. 8A having a secondary substrate affixed thereto.

FIG. 9 is a sectional view showing a modified embodiment of an as-manufactured label.

FIG. 9A is a schematic sectional view showing the removal of a first carrier sheet and release coating from the as-manufactured label of FIG. 9 and application of the remaining structure to a substrate.

FIG. 9B is a schematic sectional view showing the remaining structure applied to the substrate as shown in FIG. 9A and subsequent removal of a second carrier sheet followed by application of a secondary substrate to a water dispersible adhesive layer.

FIG. 10 is a sectional view of yet another embodiment of label structure being formed into a roll of as-manufactured labels.

FIG. 10A is a schematic sectional view showing application of the as-manufactured label structure of FIG. 10 to a substrate.

FIG. 10B is a schematic sectional view of the as-manufactured label structure of FIG. 10 engaged to the substrate of FIG. 10A and subsequently having affixed thereto a secondary substrate following removal of a protective backing.

FIG. 11 is a sectional view of a further embodiment of as-manufactured label structure.

FIG. 11A is a schematic sectional view showing removal of the protective backing sheet and release coating and application of the remaining structure to a substrate.

FIG. 11B is a schematic sectional view showing the remaining structure affixed to the substrate as shown in FIG. 11A and subsequent removal of a second protective backing sheet followed by application of a secondary substrate.

### DETAILED DESCRIPTION OF THE INVENTION

Referring to FIG. 1, there is shown one embodiment of the label of the present invention in the as-manufactured state prior to affixing to a container. The as-manufactured label L includes a release liner 1, a water dispersible adhesive layer 2, a carrier sheet 3, a conventional pressure sensitive adhesive layer 4 and a top (as viewed in FIG. 1) layer 5 intended as the outer or viewing layer and, if desired, having printed information thereon.

The first layer is a release liner 1 which may be a paper or plastic film coated with silicone, wax or other release agent. If the release liner 1 is formed of plastic film, the plastic used may be any of a wide variety including high or low density polyethylene, polyvinyl chloride, polyethylene-terephthalate among others. The second layer is a water dispersible pressure sensitive adhesive layer 2 of a type which will readily release the release liner 1 when the release liner is peeled away therefrom. An important feature of the present invention resides in the adhesive layer 2 being a water dispersible pressure sensitive adhesive in order that the label may be readily removed with water from a food or other container to which it is attached following expiration of the safe life of food or other contents of the container. The water dispersible adhesive, when dispersed in water, is reduced to particles so small that they cannot be seen by the human eye without magnification. Preferably, such dispersed particles have a maximum size of less than one millimeter (1 mm). One suitable type of water dispersible adhesive is one manufactured by Fasson Corporation as its adhesive S-2600.

Although some adhesives, such as the adhesive disclosed in U.S. Pat. No. 5,624,751, have the property of being deactivated in water to assist in removal from a container, this type of adhesive has a polymer which has an affinity for itself and forms a slurry which requires filtering-off in the recycling process. The water dispersible pressure sensitive adhesive used in the present invention as the water dispersible adhesive layer 2 utilizes ingredients which do not have affinity for themselves and, therefore, do not form undesirable slurries or other adhesive agglomerations. It is possible that adhesives which form slurries when deactivated in water could interfere with the recycling process.

The third layer carrier sheet 3 is a paper or polymeric film layer such as polyvinyl alcohol (PVOA), high or low density polyethylene, polyvinyl chloride, polyethyleneterephthalate or the like and which has a release coating on the surface facing away from the water dispersible adhesive layer 2. Preferably the third layer carrier sheet 3 is water permeable to permit ready access of water to the water dispersible adhesive layer 2 when it is desired to remove such layers from the container to which it is attached.

The fourth layer is a standard pressure sensitive adhesive layer 4 such as one manufactured by Fasson as its adhesive No. AT-20 or No. S-2500 or manufactured by Green Bay Packaging as its adhesive No. 720.

The fifth layer is a paper or polymeric or other plastic film layer 5 which can be printed upon.

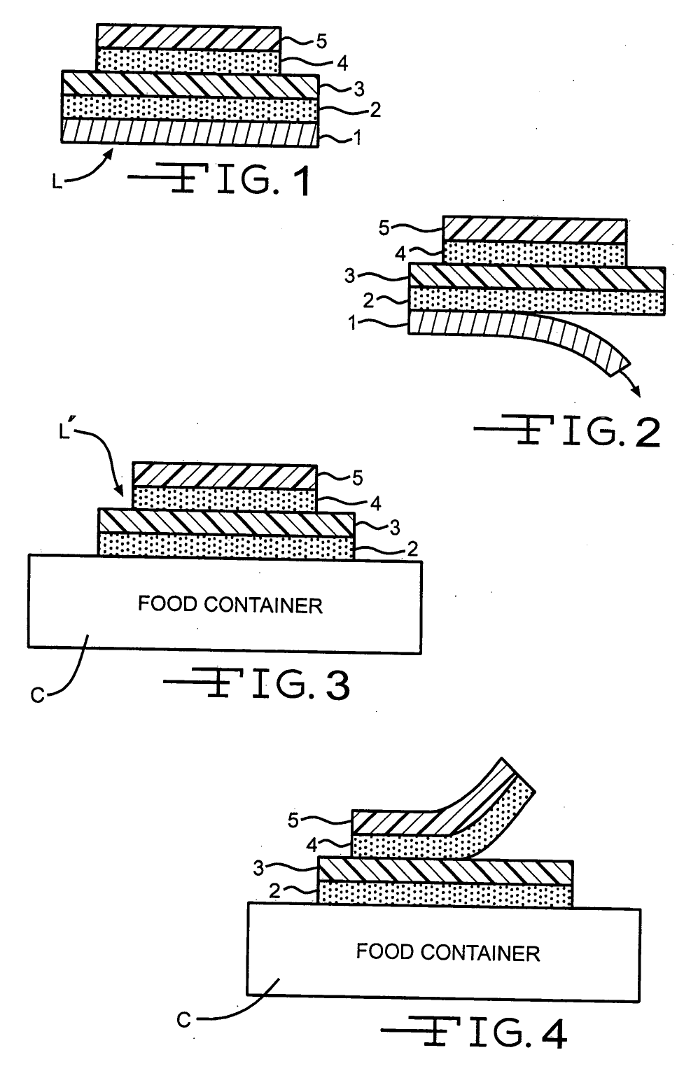

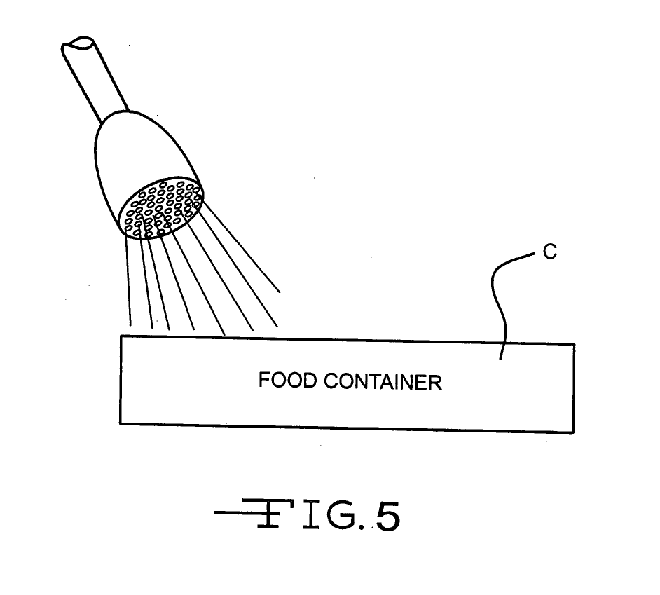

The use of the label of the present invention in a food rotation labeling application may be seen by considering the steps outlined in FIGS. 2-5. In FIG. 2, the as-manufactured label L is shown being readied for application to a food or other container C by removing the release liner 1 and thereby leaving an as-affixed label L′ with its water dispersible pressure sensitive adhesive layer 2 exposed for affixing to a wall of a food container C as shown in FIG. 3.

At any time thereafter but specifically after the expiration time for the food or other contents of the container C, the paper or film layer 5 and its adjacent pressure sensitive adhesive layer 4 may be removed and if desired, placed in a log book or other record keeping instrumentation or documentation of the label change and disposal of the container contents. Such record keeping is recommended by various agencies such as Hazard Analysis and Critical Control Point (HACCP) or International Standards Organization (ISO), for example.

As may be seen in FIG. 4, removal of the outer layers, namely, the paper or film layer 5 with printed information and the pressure sensitive adhesive layer 4 leaves the water permeable release layer 3 and the water dispersible adhesive layer 2 adhered to the container C. These layers can then be easily removed from the container C using a water wash or spray W and leaving no adhesive residue on the container.

As shown in the drawings, the edges of the pressure sensitive adhesive layer 4 and the paper or plastic film layer 5 are recessed from the edges of the carrier sheet 3. This assists in the peelability of those layers from the carrier sheet 3. However, it should be understood that the edges of all the layers could be aligned.

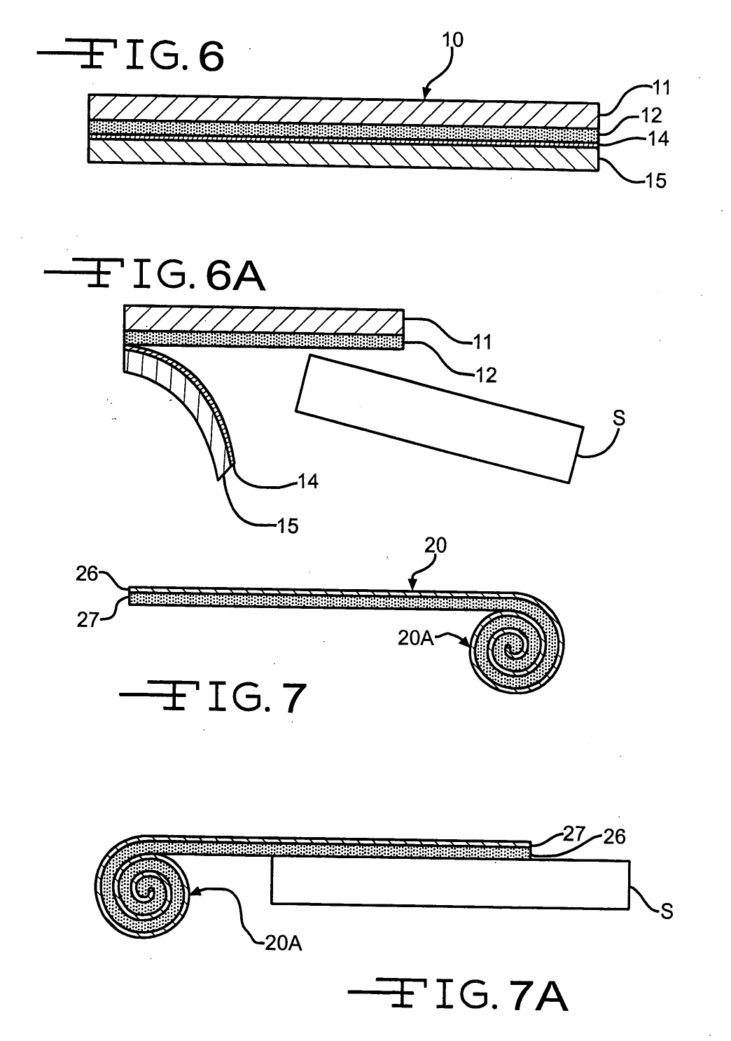

Referring to FIGS. 6 and 6A, there is shown another embodiment of label which is shown in the as-manufactured state 10 in FIG. 6. The as-manufactured label 10 includes a face layer 11, a water dispersible adhesive layer 12, a release coating 14 and a backing layer 15 which is intended to be removed, along with the release coating 14, from the water dispersible adhesive layer 12 prior to affixing to a substrate S as shown in FIG. 6A. The face layer 11 is formed of a material which is non-soluble and non-dispersible in water such as a wide variety of paper, plastic films or non-woven fabric. The water dispersible adhesive layer 12 is one which readily disperses in water of any temperature to form particles which cannot be seen by the human eye, for example, the previously referenced adhesive sold by Fasson Corporation as its Adhesive S-2600.

The backing layer 15 has a release coating 14 such as silicone or wax is engaged to the layer of water soluble adhesive 12 with the release coating 14 contacting such adhesive 12. The backing layer 15 may be one of a wide variety of well known releasable backing materials common with pressure sensitive labels. As can be seen in FIG. 6A, the backing layer 15 along with the release coating 14 is removed from the layer of adhesive 12 immediately prior to affixing the face layer 1′ and water dispersible adhesive layer 12 to the substrate S with the face layer 11 facing outwardly and the adhesive layer 12 in direct contact with the substrate S. Heretofore water dissolvable and water dispersible labels not requiring a soaking period have been produced with both water soluble or dispersible adhesive and water soluble or dispersible face materials such as the dissolving product sold by Fasson Roll North America, a division of Avery Dennison as Fasson's Specification No. 16174. The prior art labels sold by the assignee of the present invention using such water soluble face materials also utilized a water soluble adhesive such as Fasson's S-100-R adhesive which required the water to be at a relatively high temperature (140° F.) and required approximately two minutes dwell time at that temperature to be removed from the surface to which it was attached.

In contrast, the label of the embodiment of FIGS. 6 and 6A of the present invention comprise the face layer 11 which is not soluble or dispersible in water and the adhesive layer 12 which is dispersible in water.

This label may be removed from a container surface or other substrate S to which it is attached in a significantly shorter time period, for example 30 seconds or possibly less and in any temperature water, thereby avoiding the necessity of utilizing heated water. Furthermore, the label of the present invention has the advantage of allowing the label face layer 11 to remain relatively intact following its removal from the substrate S. The face layer 11 may then either be readily disposed of or, if used on food containers or other applications requiring information retrieval, it may be readily marked upon and saved. This particularly useful in food rotation labeling or inventory tracking.

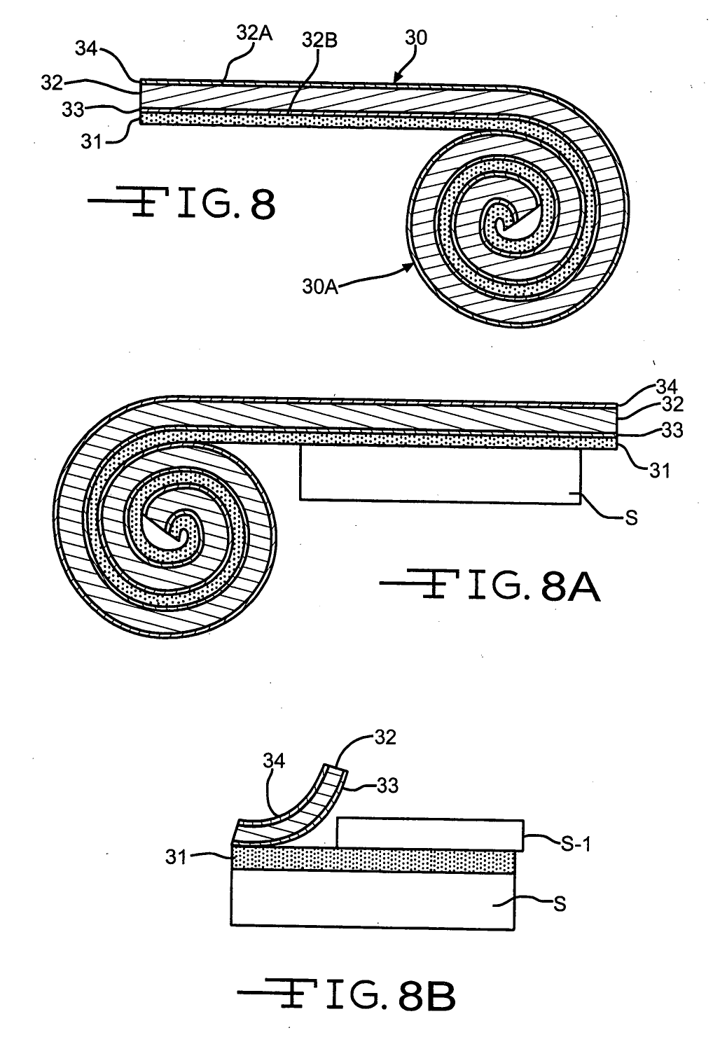

Referring to FIGS. 7and 7A, there is shown another embodiment which may be characterized as a roll structure 20 since it may be rolled upon itself to form a roll 20A such as a roll of tape. The roll structure 20 comprises a carrier or face layer 26 such as paper, plastic film or non-woven fabric which is not soluble or dispersible in water and a water dispersible adhesive layer 27 of the type utilized in the previous embodiments, for example, Fasson Corporation's adhesive S-2600. As can be seen in FIG. 7, the roll structure 20 may be rolled upon itself to form a roll 20A. When it is desired to be dispensed and adhered to a substrate S, it may be simply unwound and the adhesive layer 27 affixed to the substrate S with the carrier or face layer 26 facing outwardly therefrom. This is an advantage over presently available water soluble tapes in that the utilization of a water insoluble/non-dispersible material for the carrier or face layer 26 is lower cost than is required for water soluble tapes in which the entire tape structure is water soluble. This embodiment also has the advantage of being removable in a short period of time, about 30 seconds or less, by exposing to water of any temperature above freezing.

Referring to FIGS. 8, 8A and 8B, there is shown yet another embodiment of roll structure 30 which may be rolled upon itself to form a roll 30A, which roll 30A may be subsequently unrolled and affixed to a substrate S as shown in FIG. 8A. The roll structure 30 includes a water dispersible adhesive layer 31 of the type previously described, a carrier sheet 32 such as paper, plastic or non-woven fabric which is not soluable or dispersible in water, a first release coating 33 between the adhesive layer 31 and the carrier sheet 32 and a second release coating 34 on the opposite side of the carrier sheet 32 from the first release coating 33.

The water dispersible adhesive is one such as the previously described one sold by Fasson as its S-2600, for example. As can be seen in FIG. 8, when the roll structure 30 is rolled upon itself to form a roll 30A, the second release coating 34 will engage and become adhered to the side of the water dispersible adhesive layer 31 which is opposite the first release coating 33, the lower side of the adhesive layer 31 as viewed in FIG. 8. As will be appreciated, it is desirable that the roll 30A may be unwound so that the second release coating 34 is separated from the adhesive layer 31 without causing the adhesive layer 31 to pull away from the carrier layer 32. This is accomplished by having a first release coating 33 be one which has stronger release characteristics than that used for the second release coating 34. The use of release material for the first release coating 33 which has bonding characteristics causing a stronger bond between the adhesive layer 31 and the side 32B of carrier layer 32 than the bond between the second release coating 34 and the outer surface 32A of the carrier layer 32 results in retention of the opposite side 32B of the carrier layer 32 to the adhesive 31 upon unrolling the roll 30A.

When thus unrolled, the carrier layer 32 and water dispersible adhesive layer 31 may be engaged to a substrate S as shown in FIG. 8A. Thereafter, if desired, the carrier layer 32 may be removed or peeled away from the adhesive layer 31 and a secondary substrate S-1 affixed to the opposing surface of the adhesive of the adhesive layer 31. The first release coating 33, although having stronger release characteristics than the second release coating 34, will permit ready release of the carrier layer 32 from the adhesive layer 31. One example of a release material for use in the stronger first release coating 33 is one sold by Loparex Inc., subsidiary of UPM-KYMMENE Appeldoorn, Netherlands as its Item No. 6020. An example of a release material utilized for the weaker second release coating 34 is one sold by Loparex Inc. as its Item No. 6000. A typical use for this embodiment would be where the substrate S is a container containing food or other products and the secondary substrate S-1 is a promotional or informational tag.

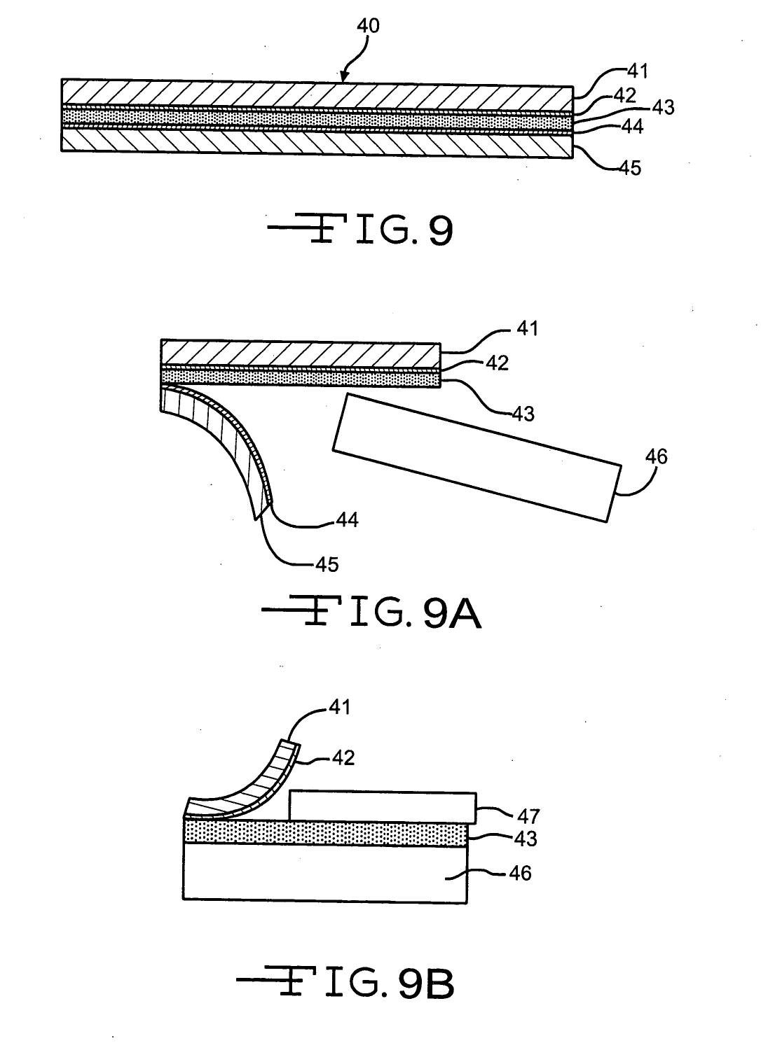

Referring to the embodiment of FIGS. 9, 9A and 9B, there is shown a further embodiment of as-manufactured label structure 40. The as-manufactured label structure 40 includes a first carrier sheet 41 which is not soluble or dispersible in water, a first release coating 42, a water dispersible adhesive 43, a second release coating 44 and a second carrier sheet 45 which is not soluble or dispersible in water. The carrier sheets 41 and 45 can be constructed a wide variety of materials including paper which is not soluble or dispersible in water, a wide variety of plastics or non-woven fabric. The release coatings can be silicone or wax based, with any one of many conventional types of release coatings being satisfactory. The release coating 42 could be formed of the same material as the release coating 44 or it could be formed from different types of coating having different release characteristics such as described in the embodiment of FIGS. 8, 8A and 8B. For example, the release coating 42 could have a stronger release characteristics in releasing the first carrier sheet 41 from the adhesive layer 43 than the release characteristics of the release coating 44 in releasing the second carrier sheet 45 from the water dispersible adhesive layer 43.

As shown in FIG. 9A, in use, the second carrier sheet 45 is peeled away from the water dispersible adhesive layer 43 carrying with it the release coating 44. The remaining portion of the as-manufactured label 40 may then have the adhesive layer 43 adhered to a first substrate 46. Thereafter, the carrier sheet 41 along with the release coating 42 may be peeled away from the adhesive layer 43 and a second substrate 47 applied to the surface of the adhesive layer 43 opposite from the side to which the first substrate 46 was attached. This embodiment permits the adhesive layer 43 to be affixed to a first substrate 46 which could be one of a wide variety of surfaces such as the outer surface of a container, for example, and the opposing side of the adhesive layer 43 to have affixed thereto a secondary substrate 47 which could be an informational tag, for example.

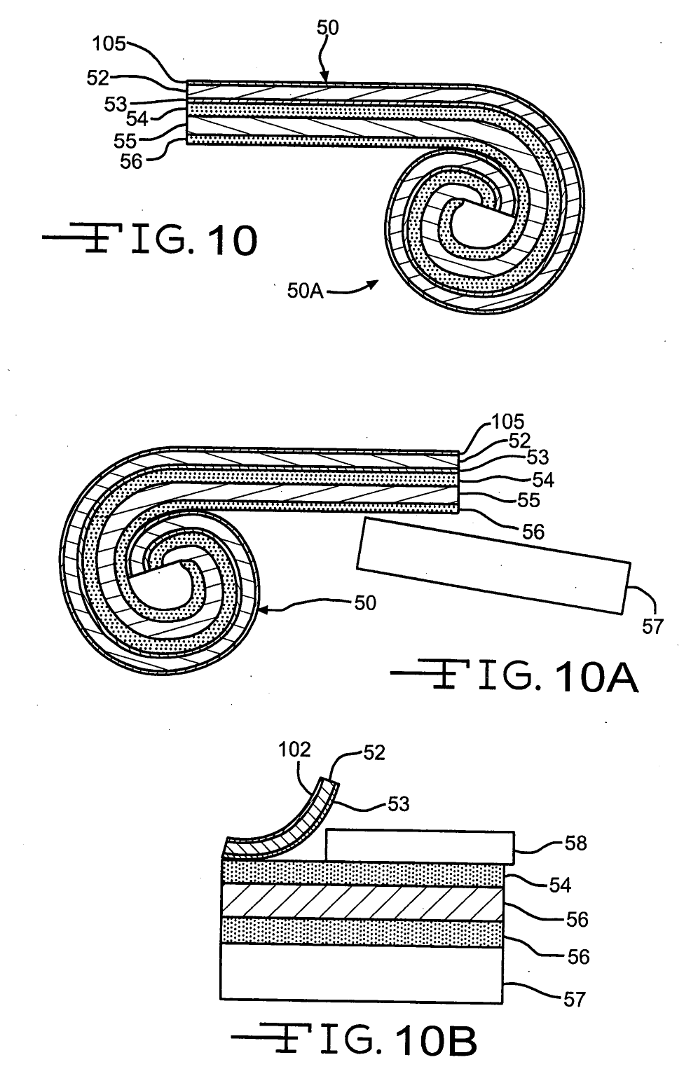

Referring to FIGS. 10, 10A and 10B, there is shown a further embodiment of as-manufactured structure 50 which is suitable for use in forming a roll 50A. Under this embodiment, the as-manufactured structure 50 includes a first release coating 51, a protective backing 52, a second release coating 53, a first water dispersible adhesive layer 54, a carrier sheet 55 which is not soluble or dispersible in water, and a second water dispersible adhesive layer 56. The water dispersible adhesive for both adhesive layers 54 and 56 are of the type previously described which is dispersible in any temperature of water.

As shown at the right of FIG. 10, the as-manufactured structure 50 is wound upon itself to form a roll 50A with the second adhesive layer 56 forming the inner most layer and the first release coating 51 in contact therewith. Although the first release coating 51 could have properties permitting it and the first protective backing 52 to be removed from the second adhesive layer 56 upon unwinding with less pull force than would be required to remove the second release coating 53 and protective backing 52 from the first adhesive layer 54, the construction of the as-manufactured structure 50 is such that the first release coating 51 can be identical to the second release coating 53.

As shown in FIG. 1A, upon unwinding of the roll 50A, a first substrate 57 may be directly adhered to the second adhesive layer 56. Thereafter, as shown in FIG. 10B, the protective backing 52 and second release coating 53 may be peeled away from the first layer of water dispersible adhesive 54 and a secondary substrate 58 secured to the side of the adhesive layer 54 opposite from the carrier 55. Preferably -the carrier 55 is not soluable or dispersible in water. As in the previous embodiment of FIG. 8B, the first substrate 57 could be the surface of a container, for example, and the secondary substrate 58 could be an informational or promotional tag. Under this embodiment, upon use of the goods on the container represented by the substrate 57 or expiration of the food contained in such container, the container with its substrate 57 and the remaining structure shown in FIG. 10B including the secondary substrate 58 may be immersed or otherwise wetted with water to permit removal of the secondary substrate 58, first water dispersible adhesive 54, carrier 55 and secondary water dispersible adhesive 56 from the substrate 57. The immersion or other wetting with water also permits removal of the secondary substrate 58 from the carrier 55 thereby leaving the carrier 55 which may be marked upon for record keeping purposes.

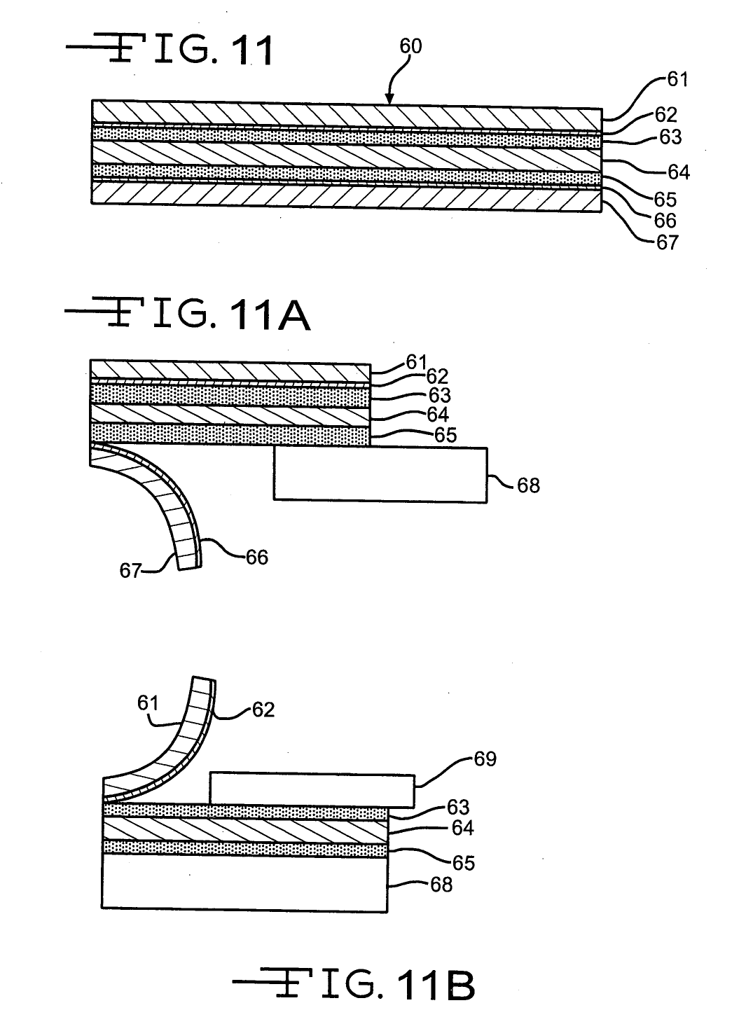

Referring to FIGS. 11, 11A and 11B, there is shown an additional embodiment of as-manufactured structure 60. The structure 60 includes a first protective backing sheet 61 which is not soluable or dispersible in water, a first release coating 62, a first water dispersible adhesive 63, a carrier sheet 64 which is not soluable or dispersible in water, a second water dispersible adhesive 65, a second release coating 66 and a second protective backing 67 which is not soluble or dispersible in water. The protective backing sheets 61 and 67 may be formed of a wide variety of materials including paper, plastic or metal foil, or non-woven fabric. The release coatings 62 and 66 may be identical or may have differing release characteristics. The insoluble carrier sheet 64 may be formed of paper which is nonsoluable/nondispersible in water or plastic film or non-woven fabric.

As shown in FIG. 11A, in use the second protective backing 67 may be peeled away from the second layer of water dispersible adhesive 65 carrying with it the second release coating 66. Thereafter a first substrate 68 may be affixed to the second adhesive layer 65. The first protective backing 61 may then be removed from the first layer of water dispersible adhesive 63, carrying with it the first release coating 62. A secondary substrate 69 may then be affixed to the layer of water dispersible adhesive 63 thereby leaving a final structure of first substrate 68 and secondary substrate 69 having sandwiched therebetween the insoluble carrier sheet 64 and the first and second layers of adhesive 63 and 65 respectively.

The as-manufactured structure 60 as shown in FIG. 11 is in effect a double sided tape with separate protective backings 61 and 67 on each layer of adhesive 63 and 65, respectively. This embodiment provides additional capabilities over the structure shown in FIGS. 10, 10A and 10B which must be immediately used upon rolling. In contract, the structure 60 of FIG. 11, although more expensive than the structure 50 of FIG. 10 and roll 50A of FIG. 10A, can be stored for extended periods of time.

Many modifications will become readily apparent to those skilled in the art. Accordingly, the scope of the present invention should be determined solely by the scope of the appended claims.

1. A label comprising
(a) a layer of water dispersible adhesive positioned for engagement with a surface of a container or other article;
(b) a carrier sheet having (i) a first surface overlying said layer of water dispersible adhesive and (ii) a second surface;
(c) a layer of pressure sensitive adhesive overlying said second surface; and
(d) a paper or plastic film layer having an inner surface overlying said layer of pressure sensitive adhesive and an outer surface for viewing, said paper or plastic film layer being non-soluble in water.

2. A label according to claim 1 further including a release layer releasably engaged to the opposite side of said layer of water dispersible adhesive from said carrier sheet, said release layer being removable from said layer of water dispersible adhesive prior to engaging said layer of water dispersible adhesive to said container.

3. A label according to claim 1 wherein said paper or plastic film layer is removably secured to said carrier sheet by said layer of pressure sensitive adhesive.

4. A label according to claim 1 wherein said carrier sheet is water permeable.

5. A method of recording usage of products contained in a container comprising the steps of
(a) affixing a label to a container holding or intended for holding said products, said label including
(i) a layer of water dispersible adhesive contacting said container;
(ii) a carrier sheet having (i) a first surface overlying said layer of water dispersible adhesive and (ii) a second surface;
(iii) a layer of pressure sensitive adhesive overlying said second surface; and
(iv) a paper or plastic film layer having an inner surface overlying said layer of pressure sensitive adhesive and an outer surface, said plastic or film layer being non-soluble ire water;
(b) removing said layer of pressure sensitive adhesive and said paper or plastic film layer from said carrier sheet; and
(c) applying water or a water based dispersion agent to said container to remove said layer of water dispersible adhesive and said carrier sheet from said container.

6. The method according to claim 5 further including the step of dispersing said water dispersible adhesive during step (c) to an extent that no particles of said water dispersible adhesive are visible to the human eye.

7. The method according to claim 5 further including the step of recording indicia on said paper or plastic film layer shortly before its removal from said carrier sheet.

8. The method according to claim 5 further including the step of recording indicia on said paper or plastic film layer after its removal from said carrier sheet.

9. The method according to claim 5 further including the steps of providing a release liner on the side of said layer of water dispersible adhesive opposite said carrier sheet and removing said release liner immediately prior to affixing said layer of water dispersible adhesive to said container.

10. A label for affixing to a surface comprising
(a) a first layer for engagement to a surface, said first layer being an adhesive which is dispersible in water; and
(b) a second layer which is non-soluble in water, said second layer being a member of the group consisting of paper, plastic film and non-woven fabric.

11. A label for affixing to a surface according to claim 10 wherein said adhesive is dispersible in water to an extent that particles of said adhesive are so dispersed that they cannot be seen by the human eye.

12. A label for affixing to a surface according to claim 10 wherein said adhesive as dispersed in water forms particles which have a maximum size of one millimeter.

13. A label for affixing to a surface according to claim 10 wherein said label may be removed from said surface by wetting with water and said second layer, following removal from said surface and drying, may be written upon.

14. A label for affixing to a surface according to claim 10 further including a backing layer with a release coating engaged to the opposite side of said first layer from said second layer.

15. A label for affixing to a surface according to claim 10 wherein said adhesive has the property permitting removal of said label from said surface in no more than thirty (30) seconds when subjected to water at a temperature in the range of 32° F. to 212° F.

16. A label for affixing to a surface according to claim 10 further including a first release coating between said first layer and said second layer and a second release coating on the opposite side of said second layer from said first release coating, said first release coating requiring greater force for removing said first layer from said second layer than the force required to remove the opposite side of said second layer from an adjacent adhesive layer.

17. A roll of labels for affixing to a surface, said labels comprising
(a) a first layer having a first side for engagement to said surface and a second side, said first layer being an adhesive which is dispersible in water;
(b) a second layer which is non-soluble in water, said second layer having an inner side and an outer side, said inner side adhered to said first layer second side, said second layer being a member of the group consisting of paper, plastic film and non-woven fabric; and
(c) a first release coating on either (i) the first side of said first layer or (ii) the outer side of said second layer, said first release coating being in contact with said first layer first side following formation of said roll, said first release coating permitting the unrolling of said roll without said first layer second side being pulled away from said second layer inner side.

18. A roll of labels according to claim 17 further including a second release coating between said first layer second side and said second layer inner side, said first release coating permitting unrolling disengagement of said second layer from said first layer first side without causing disengagement of said first layer second side from said second layer inner side.

19. A roll of labels according to claim 18 wherein said second release coating requires greater force to remove said first layer second side from said second layer inner side than said first release coating requires to remove said first layer first side from said second layer.
